(19) United States
(12) Patent Application Publication
(10) Pub. No.: US 2026/0249662 A1
(43) Pub. Date: Aug. 27, 2026

(54) CLIMATE CONTROLLER AND CLIMATE CONTROL METHOD

(71) Applicant: JAGUAR LAND ROVER LIMITED, Whitley, Coventry, Warwickshire (GB)

(72) Inventors: Phil HARRISON, Whitley, Coventry, Warwickshire (GB); John HALL, Whitley, Coventry, Warwickshire (GB); Richard JOHNSON, Whitley, Coventry, Warwickshire (GB); Hongjun CHEN, Whitley, Coventry, Warwickshire (GB); Lin LI, Whitley, Coventry, Warwickshire (GB); Lifeng HUANG, Whitley, Coventry, Warwickshire (GB); Shize CEN, Whitley, Coventry, Warwickshire (GB); Jianqing ZHANG, Whitley, Coventry, Warwickshire (GB); Qiangyin ZHANG, Whitley, Coventry, Warwickshire (GB); Zhenping LI, Whitley, Coventry, Warwickshire (GB)

(21) Appl. No.: 18/877,923

(22) PCT Filed: Jun. 20, 2023
(86) PCT No.: PCT/EP2023/066586

§ 371 Date: Dec. 20, 2024

(30) Foreign Application Priority Data
Jun. 21, 2022 (CN) 202210704037.7
Jun. 21, 2022 (CN) 202221565143.3
Jun. 30, 2022 (CN) 202210756449.5
Jan. 5, 2023 (GB) 2300160.5
Jan. 5, 2023 (GB) 2300162.1

(51) Int. Cl. B60H 1/00; B60H 1/34

(52) U.S. Cl. CPC B60H 1/00735; B60H 1/00871; B60H 1/3421

(57) ABSTRACT

A climate control system of a vehicle comprising a vent having adjustable flow-direction control and an actuator for adjusting the flow-direction of the vent. The control system is configured to determine a dynamic vent control scheme which defines a plurality of vent flow-directions, and output an actuator control signal to control the vent in accordance with the dynamic vent control scheme to effect a dynamic vent operation mode. Also a method for controlling the parameters of the dynamic vent control scheme via a user interface which comprises a graphical display of the dynamic vent control scheme.

### CROSS REFERENCE TO RELATED APPLICATIONS

The present application is a U.S. National Phase of International Application No. PCT/EP2023/066586 entitled “CLIMATE CONTROLLER AND CLIMATE CONTROL METHOD,” and filed on Jun. 20, 2023. International Application No. PCT/EP2023/066586 claims priority to Chinese Patent Application No. 202210704037.7 filed on Jun. 21, 2022, Chinese Patent Application No. 202221565143.3 filed on Jun. 21, 2022, Great Britain Patent Application No. 2300162.1 filed on Jan. 5, 2023, Great Britain Patent Application No. 2300160.5 filed on Jan. 5, 2023, and Chinese Patent Application No. 202210756449.5 filed on Jun. 30, 2022. The entire contents of each of the above-listed applications are hereby incorporated by reference for all purposes.

### TECHNICAL FIELD

The present disclosure relates to a controller for a vehicle climate system and to a method of controlling a climate system of a vehicle and particularly, but not exclusively, to a controller and a method for controlling a vent of a climate system. Aspects of the invention relate to a control system, to a climate system comprising the control system, to a method, to a vehicle comprising the control system and/or climate system, to computer software arranged to perform the method, and to a non-transitory computer-readable storage medium storing instructions to carry out the method.

### BACKGROUND

It is well known to provide vehicle climate control systems which are operable to maintain a set temperature throughout, or in a specific zone of, a passenger compartment. It is also known to control a vehicle climate system to attain a set temperature as rapidly as possible before automatically adjusting a fan speed of the climate control system once the requested temperature has been attained.

The majority of vehicle climate control systems comprise a number of air vents positioned around the passenger compartment. The air vents are typically directed towards specific areas of the passenger cabin such as the passenger foot compartment, the passenger body/face position, the windscreen and the side windows. In some cases, such as with the body/face vents, the flow-direction of the air vents is adjustable so that passengers may direct the air flow towards a location most preferred by them. In other cases, such as with the foot and window vents, the flow-direction of the air vents is fixed.

Traditionally, adjustable air vents have been provided with a handle or wheel by which passengers are able to manually adjust the flow direction of the air-vent. Latterly, electronically adjustable air vents have been introduced which allow a passenger to input their preferred air-flow direction into a user interface device which forms part of a vent control system. The requested air-flow direction is processed by the control system and provided as an input signal to an actuator which positions the air vent at the requested position.

It is also known to utilise the climate control system to pre-condition the passenger compartment before departure of the vehicle. This is especially beneficial for electric vehicles as energy intensive heating or cooling can be achieved to bring the passenger compartment to a comfortable climate while the vehicle is still plugged into a source of power.

It is against this background that the present invention has been developed.

### SUMMARY OF THE INVENTION

Aspects and embodiments of the invention provide a control system, a climate system, a method, a vehicle, computer software and a non-transitory, computer-readable storage medium as claimed in the appended claims.

According to an aspect of the present invention there is provided a control system for controlling a climate system of a vehicle, the climate system comprising a vent having adjustable flow-direction control and an actuator for adjusting the flow-direction of the vent, the control system comprising one or more controllers, the control system configured to: determine a dynamic vent control scheme, wherein the dynamic vent control scheme defines a plurality of vent flow-directions; and output an actuator control signal to control the actuator to adjust the vent flow-direction in accordance with the dynamic vent control scheme to effect a dynamic vent operation mode.

The control system of the present invention is advantageous as it provides dynamic air-flows within the passenger compartment of the vehicle thereby helping to distribute heating/cooling air-flow more evenly throughout the passenger compartment, and providing an enjoyable sensation for the vehicle occupants.

The one or more controllers may collectively comprise: at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to: determine a dynamic vent control scheme, wherein the dynamic vent control scheme defines a plurality of vent flow-directions; and output an actuator control signal to control the actuator to adjust the vent flow-direction in accordance with the dynamic vent control scheme to effect a dynamic vent operation mode.

Optionally the control system may be configured to: receive an input signal indicative of a dynamic vent parameter, wherein the dynamic vent parameter comprises a flow direction, a circulation direction, a pattern, a passenger compartment height, a passenger compartment width, a pattern width or a pattern height; and determine the dynamic vent control scheme in dependence on the dynamic vent parameter. The use of a dynamic vent parameter is advantageous as it allows users to select the characteristics of the dynamic vent control scheme as best suits their needs or preferences.

The climate system may optionally comprise at least one of: a fan having electronically adjustable control; a heater having electronically adjustable control; an air conditioner having electronically adjustable control; a fragrance distribution system having electronically adjustable control; or an atmospheric air inlet having electronically adjustable control, wherein the control system is configured to: receive a second input signal indicative of a climate control parameter, wherein the climate control parameter comprises a fan speed, a temperature, an air conditioning request, a fragrance request, or an air re-circulation request; determine a climate control signal in dependence on the climate control parameter; and output the climate control signal during dynamic vent operation mode to control the fan, the heater, the air conditioner, the fragrance distribution system, or the atmospheric air inlet to operate in accordance with the climate control signal. The use of a climate control parameter is advantageous as it allows users to select climate conditions which best suits their needs or preferences.

The control system may be configured to: store the dynamic vent control scheme, the dynamic vent parameter, and/or the climate control parameter; and default to the stored dynamic vent control scheme, the stored dynamic vent parameter, and/or the stored climate control parameter when the climate system is powered on, and/or when dynamic vent operation mode is initiated. This is beneficial as the system settings need not be entered into the control system each time it is turned on, or each time a dynamic operation mode is initiated.

In one example, the control system may be configured to: receive a third input signal indicative of a user identification; store the dynamic vent control scheme, the dynamic vent parameter, and/or the climate control parameter as a user specific climate profile associated with the user identification; and default to the user specific climate profile following receipt of the third signal. A user's preferred climate system settings are thereby conveniently effected by the control system upon detection of a specific user.

Optionally the control system may be configured to: receive a fourth input signal indicative of a vehicle occupant's behaviour; determine, based on the indicated behaviour of the vehicle occupant and a pre-determined behaviour criteria, if the vehicle occupant is experiencing a pre-specified physical or mental condition; if it is determined that the vehicle occupant is experiencing a pre-specified physical or mental condition, determine a condition dependent climate system configuration in dependence on the pre-specified condition, wherein the condition dependent climate system configuration comprises one or more condition dependent dynamic vent parameters or one or more condition dependent static vent flow-directions, one or more condition dependent climate control parameters, and/or a condition dependent dynamic vent control scheme; and determine the actuator control signal and/or the climate control signal in dependence on the condition dependent climate system configuration. This is beneficial as the climate system configuration can be automatically adjusted to provide relief for certain conditions such as tiredness or agitation.

The control system may optionally be configured to: monitor the vehicle occupant's behaviour; determine one or more occupant specific behaviour criteria; and adjust the pre-determined behaviour criteria for the occupant in accordance with the occupant specific behaviour monitored. This is advantageous as the system can automatically adjust the criteria which needs to be met in order to trigger a particular condition dependent response to take account of user specific characteristics such as skin tone, body temperature, typical movement patterns etc.

The control system may be configured to: store the occupant specific behaviour criteria; and adjust the pre-determined behaviour criteria in accordance with the stored occupant specific behaviour criteria following receipt of an occupant specific input signal so that the appropriate occupant specific behaviour criteria is loaded into the system upon detection of a specific user.

In one example, the control system may be configured to: store an occupant specific condition dependent climate system configuration; and adjust the condition dependent climate system configuration in accordance with the occupant specific condition dependent climate system configuration following receipt of an occupant specific input signal. This allows the user to set their preferred system response to the detection of any particular pre-specified condition.

Optionally the control system may be configured to: receive a fifth input signal indicative of a request for a pre-defined use-case operation mode, wherein the pre-defined use-case operation mode comprises one or more pre-defined use-case vent parameters, wherein the one or more pre-defined use-case vent parameters comprise a pre-defined use-case static vent flow direction, or one or more pre-defined use-case dynamic vent parameters; determine a pre-defined use-case vent control scheme in dependence on the pre-defined use-case vent parameters; output an actuator control signal to control the actuator to adjust the vent flow-direction in accordance with the pre-defined use-case vent control scheme; and switch operation mode from the pre-defined use-case operation mode to the dynamic vent operation mode after a pre-determined period of time, upon request, or upon receipt of an input signal indicating that that a pre-determined climate condition criteria or vehicle condition criteria has been satisfied. This is advantageous as the user can readily select certain climate system configurations associated with the use-cases without having to programme the system each time. The user can select pre-programmed use-cases and/or the user can input bespoke use-cases into the control system.

The control system may optionally be configured to: receive a sensor input signal, wherein the sensor input signal is indicative of a climate condition within the vehicle or a condition of the vehicle; determine if the indicated climate condition or condition of the vehicle satisfies a pre-determined climate condition criteria or vehicle condition criteria based on the sensor input signal; and if the pre-determined climate condition criteria or vehicle condition criteria is satisfied, issue a criteria is satisfied control signal, wherein the control system is configured to switch operation mode only after issue of the criteria is satisfied control signal. This is beneficial as the control system is able to switch between modes of operation or use-cases upon detection that a particular condition has been achieved within the vehicle.

The control system may be configured to: adjust one or more of the dynamic vent control scheme, the climate control signal, the condition dependent climate system configuration, or the pre-defined use-case vent control scheme in dependence on which parts of the climate system are active, the steering wheel position, an inferred or sensed head position, the extent of window opening, vehicle occupancy, use of ancillary heating or cooling devices, and/or external environmental conditions. This is advantageous as the climate control system can be used more efficiently to best suit the particular configuration of the various vehicle systems and or the location/physical attributes of the vehicle occupants.

In one example the control system may comprise: a display screen; and a touch and/or gesture operated user interface device, wherein the control system is configured to: display a graphical representation of the dynamic vent control scheme on the display screen; adjust the dynamic vent control scheme in response to a user interaction with the user interface device; and adjust the graphical representation of the dynamic vent control scheme in response to the user interaction with the user interface device, wherein the adjusted graphical representation is representative of the adjusted dynamic vent control scheme. The user interface device may be integral with the display screen. Visual representation of the dynamic vent control scheme is an efficient and clear way of imparting information concerning the system settings to the user. The graphical display may be augmented with representations of elements within the passenger compartment such as the steering wheel, seats or vents (for example) to enhance the user's understanding of how the dynamic air-flow is realised within the vehicle.

According to another aspect of the present invention there is provided a system, comprising: a vent having adjustable flow-direction control; an actuator for adjusting the flow-direction of the vent; and the control system described above, including at least a first controller, wherein the at least a first controller is arranged to output a signal for causing the actuator to adjust the vent flow-direction in accordance with the dynamic vent control scheme to effect a dynamic vent operation mode.

According to a further aspect of the present invention there is provided a method for controlling a climate system of a vehicle, the climate system comprising a vent having adjustable flow-direction control and an actuator for adjusting the flow-direction of the vent, the control system comprising one or more controllers, the method comprising: determining a dynamic vent control scheme, wherein the dynamic vent control scheme defines a plurality of vent flow-directions; and outputting an actuator control signal to control the actuator to adjust the vent flow-direction in accordance with the dynamic vent control scheme to effect a dynamic vent operation mode.

According to a still further aspect of the present invention there is provided a vehicle comprising the control system described above or the system describe above.

According to yet another aspect of the present invention there is provided method for controlling a climate control system of a vehicle, wherein the climate control system has a dynamic vent operation mode in which a dynamic air movement pattern is automatically effected by one or more vents having electronically actuable flow-direction control, the method comprising: displaying a graphical representation of the dynamic air movement pattern on a display screen, wherein the graphical representation comprises a representation of a width and/or a height of the dynamic air movement pattern; adjusting the width and/or a height of the dynamic air movement pattern in response to a user interaction with a user interface device; and adjusting the graphical representation of the dynamic air movement pattern in response to the user interaction with the user interface device, wherein the adjusted graphical representation is representative of the adjusted dynamic air movement pattern.

According to an aspect of the present invention there is provided computer software that, when executed, is arranged to perform either of the methods described above.

According to another aspect of the present invention there is provided a non-transitory, computer-readable storage medium storing instructions thereon that, when executed by one or more electronic processors, causes the one or more electronic processors to carry out either of the methods described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic illustration of a vehicle in accordance with an embodiment of the invention;

FIG. 2 shows a block diagram of a control system such as may be adapted in accordance with an embodiment of the invention;

FIG. 3 shows a schematic drawing of a graphical user interface such as may be adapted in accordance with an embodiment of the invention; and

FIG. 4 shows a simplified example of a control system such as may be adapted in accordance with an embodiment of the invention.

FIG. 5 shows structural elements of a vent assembly.

FIG. 6 shows the sequence of airflow configurations as a function of rotational position of the vent shaft.

### DETAILED DESCRIPTION

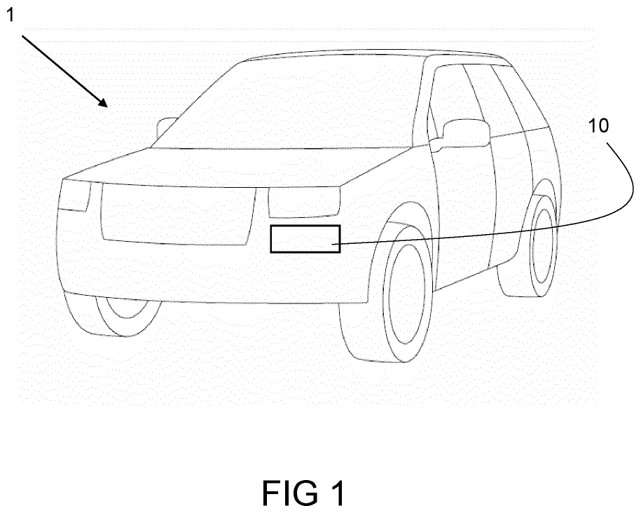

A vehicle 1 in accordance with an embodiment of the present invention is described herein with reference to the accompanying FIG. 1.

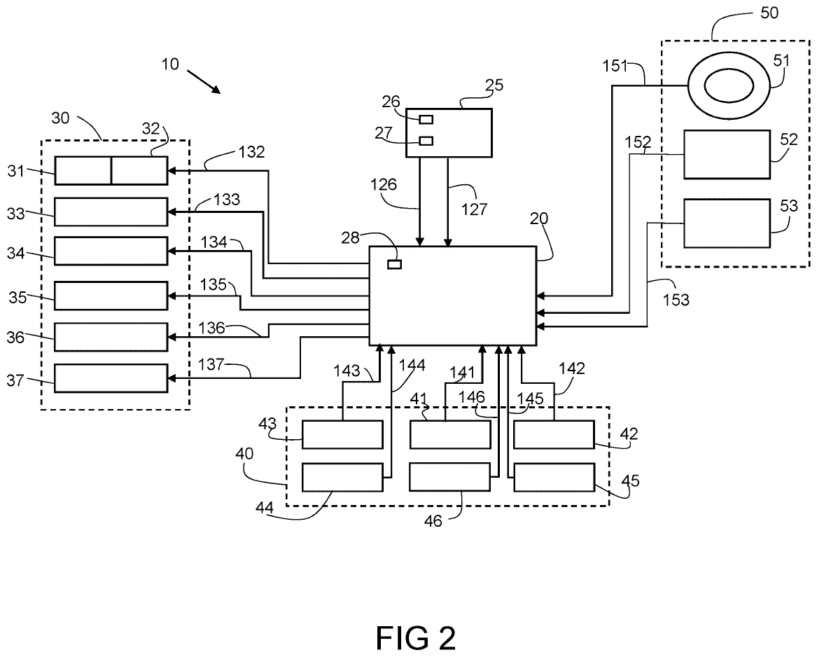

The vehicle 1 comprises a control system 10 for controlling a climate system 30 (FIG. 2) of the vehicle 1 as will be described in greater detail below.

Referring to FIG. 2, the control system 10 comprises a controller 20 which is configured to communicate with the climate system 30, sensors 40 and vehicle systems 50. The controller 20 is also configured to communicate with one or more user interfaces 25 (which may be a graphical user interface). It will be understood that the communication between the controller 20 and the climate system 30, the sensors 40, the vehicle systems 50 and the user interface 25 is electronic communication which may be effected via wired connections (such as a communications loom) or via wireless connections. Any combination of wired or wireless communication techniques may be used.

The climate system 30 comprises one or more vents 31 having adjustable flow-direction control and one or more actuators 32 which are configured to adjust the flow-direction of the vents 31 upon receipt of an actuator control signal 132 from the controller 20. The climate system 30 may also comprise non-adjustable vents (not shown).

One or more electronically adjustable fans 33 are provided for creating air-flow through the adjustable vents 31 (and non-adjustable vents if present). In addition, the climate system 30 comprises an electronically adjustable heater 34, an electronically adjustable air conditioner 35, an electronically adjustable atmospheric air inlet valve 36, and an electronically adjustable fragrance distribution system 37. It will be understood that in more simple climate systems the air conditioner 35, the atmospheric air inlet valve 36 and/or the fragrance distribution system 37 may be omitted.

The controller 20 is configured to communicate with one or more sensors 40 which may comprise an internal climate sensor 41 for sensing the temperature, humidity and/or air-quality within the passenger compartment. Alternatively, one or more separate internal climate sensors may be provided for detecting one or more of the above-mentioned internal climate factors in groups or separately.

The sensors 40 may also comprise a camera 42 (which may have infra-red capability), a weight sensor 43 for detecting the weight of a passenger on a seat, a fragrance sensor 44 such as an electronic nose, a user identification indicator 45 which may be a mobile telephone or a vehicle key, and/or an external climate sensor 46 for sensing the temperature, humidity and/or air-quality outside the vehicle 1. The external climate sensor 46 may also detect wind speed, precipitation, air pressure, direct sunlight exposure and/or cover/housing (for example a car-port or garage). Alternatively, separate external climate sensors may be provided for detecting one or more of the above-mentioned external climate factors in groups or separately.

The controller 20 is also configured to communicate with one or more vehicle systems 50 which may comprise a steering wheel 51, a seat 52 and/or a window 53. The steering wheel 51 and/or the seat 52 may be equipped with electrical heating or cooling provided, for example, by a Peltier device. The window 53 may be provided with electrical heating provided, for example, by embedded or printed electrically resistant wires.

The user interface 25 may comprise a single user interface which can be operated to control one or more aspects of the control system 10 such as the fan speed, temperature set point vent position etc. Alternatively the user interface may comprise separate user interfaces for controlling one or more parameters of the control system 10. For simplicity, a single user interface 25 is referenced in the description which follows. However it will be understood that one or more user interfaces may be used instead.

The user interface 25 may be configured to allow a user to set a desired climate system configuration. The climate system configuration may comprise a vent parameter 26 such as a vent flow-direction. The user interface 25 is configured to provide the vent parameter 26 as a vent parameter input signal 126 to the controller 20.

The vent parameter 26 may be a static vent parameter dictating a fixed flow-direction of the vent 31, or a dynamic vent parameter which comprises information concerning how the vents 31 should move during operation of the climate system 30 in a dynamic vent operation mode. The vent parameter 26 may comprise settings detailing flow direction, circulation direction, flow pattern, flow pattern dimensions and/or passenger compartment dimensions. Each vent parameter 26 is provided to the controller 20 as a vent parameter input signal 126.

The controller 20 may use each vent parameter to determine a vent control scheme 28 which forms part of the climate system configuration. The vent parameter 26 is issued as an output actuator control signal 132 to the actuator 32 to operate the actuator 32 to adjust the vent flow-direction in accordance with the vent control scheme 28 in use. If dynamic vent parameters 26 are set, the vent control scheme 28 is a dynamic vent control scheme 28 which defines a plurality of vent flow-directions to be effected in use. If no vent parameters 26 are set, the controller 20 may determine a vent control scheme 28 which may be a pre-set static or dynamic vent control scheme 28. In one example, the controller 20 may comprise a plurality of stored vent control schemes 28 which may be selected by the user as a vent parameter 26 via the user interface 25. Alternatively, a stored vent control scheme 28 may be associated with a specific user as described in greater detail below.

The user interface 25 may be used to select a dynamic operation mode in which the actuator 32 is operated to move the vent 31 in accordance with a dynamic vent control scheme, or a static operation mode in which the actuator 32 is operated to move the vent 31 to a fixed position (or to hold the vent in that position if it is already there). Alternatively, the controller 20 may be configured to default to a static or dynamic operation mode in the absence of a request for any particular operation mode.

The dynamic operation mode may comprise any combination of available vent movements which may comprise a periodic scanning of the vent flow-direction over a specified vertical extent and/or across a specified horizontal extent. Alternatively, the flow-direction may move around a specified pattern such as a clockwise or anticlockwise circulation. The precise nature of the dynamic vent control scheme may be specified by the used via the user interface 25 as dynamic vent parameter inputs 26 and may include a pattern shape, pattern height or width, a circulation direction and/or passenger compartment dimensions.

The user interface 25 may also be configured to allow a user to set a climate control parameter 27 such as a fan speed, a temperature, an air-conditioning request, an air re-circulation request and/or a fragrance request. The user interface 25 is configured to provide the climate control parameter 27 as a climate control parameter input signal 127 to the controller 20.

The controller 20 is configured to issue an output climate control signal to each of the electronically adjustable climate systems such that the controller 20 may issue a fan control signal 133 to the fan 33, a temperature control signal 134 to the heater 34, an air conditioning control signal 135 to the air conditioner 35, a valve control signal 136 to the atmospheric air inlet valve 36 and/or a fragrance control signal 137 to the fragrance distribution system 37. Each of the fan 33, the heater 34, the air conditioner 35, the atmospheric air inlet valve 36 and/or the fragrance distribution system 37 are configured to operate in accordance with the respective climate control signal.

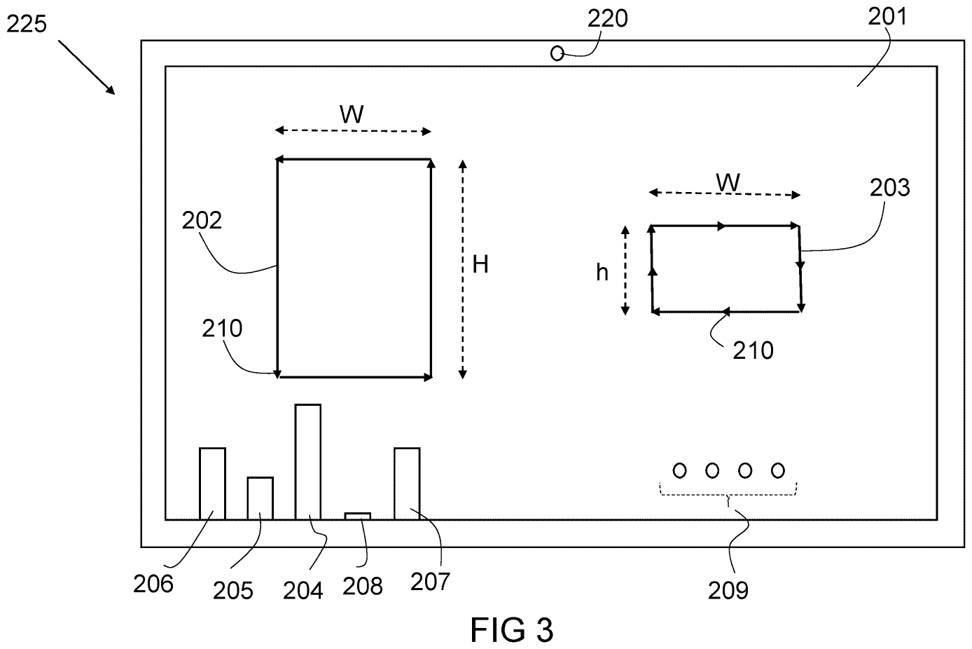

Referring to FIG. 3, the user interface 25 may be a graphical user interface (GUI) 225 comprising an interactive display screen 201 which is configured to display graphical representations of climate system settings and which is configured so that a user may adjust the climate system settings by interaction with the GUI 225. The display screen 201 may be touch operated such that the user adjusts the climate settings by touching the display screen 201. Alternatively or additionally, the GUI may comprise one or more cameras 220 which are configured to track a user's hand movements and to convert such hand movements into climate setting adjustments.

No matter how the climate settings are adjusted, the GUI is configured to display the active climate system settings so that the user may easily see the climate system configuration. The GUI may also be configured to animate the shift from one climate system setting to another. If the shift from one climate setting to another occurs over a period of time (such as a temperature rise) the GUI may be configured to represent one or both of the target climate setting and the current progress towards it.

The display screen 201 may display a graphical representation of a dynamic vent control scheme. In the example shown in FIG. 3, two dynamic vent control schemes are illustrated, one for each from passenger of the vehicle 1. In this example, both passengers have selected a circulating flow pattern with the left side passenger having selected an anti-clockwise circulation and the right side passenger having selected a clockwise circulation. The left side circulating flow pattern 202 is set to a greater height H than the right side circulating flow pattern 203 which has a pattern height h. Both flow patterns 202, 203 have the same pattern width W. The left side flow pattern 202 is set at a slower circulation speed than the right side flow pattern 203 as represented by the greater number of flow direction arrows 210 on the right side flow pattern 203.

It will be understood that the flow patterns 202, 203 described above are examples only and that any desired dynamic vent control scheme may be selected or created by the users. For example, the flows may move side to side, up and down or diagonally. If only one user is present, or if only one climate system configuration is desired, the system may operate as described above with the flow pattern covering only the user's position in the vehicle 1, or with the flow pattern covering some or all of the passenger compartment.

As shown in FIG. 3, the GUI 225 may also comprise graphical representations of the climate control parameters 27 such as fan speed 204, temperature 205, air conditioning 206, air re-circulation 207 and/or fragrance 208. The user may also select specific zones of the passenger compartment to which the climate setting will be applied via zone icons 209.

It will be understood that the GUI 225 may be configured in many different ways and that the above description is one example only. In particular, the description above is given in the context of a dynamic vent operation mode. It will be understood that the GUI 225 may also be used to set or select the climate system configuration during static vent operation mode.

The control system 10 may be configured so that any particular climate system configuration (comprising a vent control scheme, one or more vent parameters and/or one or more climate control parameters) may be stored and recalled on the next occasion that the control system 10 is powered on, or when a particular mode of operation is initiated. For example, the system may be configured so that the climate system reverts to the last climate system configuration when the vehicle 1 is powered on after having been shut down. The control system 10 may be configured to store and recall a particular climate system configuration associated with a dynamic and/or static vent operation mode so that the stored climate system configuration is automatically set when a dynamic or static vent operation mode is initiated.

The control system 10 may be configured to receive a user identification input signal 145 to the controller 20 from the user identification indicator 45. The user identification indicator may be a key fob associated with a specific user, or a mobile telephone associated with a specific user. Alternatively or additionally, the controller 20 may be configured to receive a camera input signal 142 from the camera 42, or a weight signal 143 from the weight gauge 43, and to process the camera and/or weight input signal 142, 143 to identify a specific user using stored user specific biometric information. As such, the camera/weight input signal 142, 143 may also be referred to as a user identification signal when used in this way.

The control system 10 may be configured to store a particular climate system configuration as a user specific climate profile to be recalled upon detection of the user specific identification signal 145. The control system 10 may be configured to automatically associate the current climate system configuration with a user and to store that climate system configuration as a user specific climate profile. Alternatively or additionally, the control system 10 may be configured to allow a user to store one or more climate system configurations to their profile. For example, a user may store different climate system configurations for dynamic and static modes of operation.

The control system 10 may be configured to identify that more than one specific user is present in the vehicle 1 and to identify in which zone of the passenger compartment that user is located. This may be achieved by identification of a user specific key fob or mobile telephone input signal 145 in a specific zone of the passenger compartment, and/or by using the camera/weight input signal 142, 143. The control system 10 may then set the climate system configuration in the specific zone of the passenger compartment identified as being occupied by the user to their user specific climate profile.

The control system 10 may be configured to monitor the external physical and/or environmental conditions surrounding the vehicle 1 via one or more input signals 146 provided to the controller 20 from the external climate sensor 46. The control system 10 may monitor the external conditions and associate the external conditions with the current climate system configuration. The control system 10 may then store this information and recall the climate system configuration associated with particular external conditions and default to that climate system configuration when the same or similar external conditions are identified. The association of particular external conditions with a particular climate system configuration may be independent of user or may be stored as part of a user specific climate profile.

The control system 10 may be configured to monitor the behaviour of a vehicle occupant and determine, based on the occupant's behaviour, if the occupant is experiencing a physical or mental condition. For example, the occupant may be agitated or tired, or may be suffering with a fever. The input signal 142 from the camera 42 may be used to monitor the vehicle occupant's behaviour such as blinking, head nodding, yawning, face colour and hand gestures. If the camera 42 has infra-red capability, the camera signal 142 may also be used to monitor the occupant's body temperature. Alternatively or additionally, other sensors located in the vehicle 1 may be used to monitor the vehicle occupant's behaviour such as movement sensors located in the seats to detect shifting of position, or moisture sensors located on the steering wheel 51 to detect sweaty palms.

The determination of whether the occupant is experiencing a pre-specified physical or mental condition may be achieved by comparing the monitored behaviour to one or more stored behaviour criteria. For example, there may be a pre-determined behaviour criteria which indicates that the occupant is sleepy, another to indicate agitation, and another to indicate a fever.

If it is determined that the occupant is experiencing a pre-specified physical or mental condition, the control system 10 may determine a condition dependent climate system configuration associated with that condition and adjust the vent control scheme 28, the vent parameters 26 and/or the climate control parameters 27 in order to cause the climate system 30 to automatically switch to operating according to the condition dependent climate system configuration.

The behaviour of each vehicle occupant may be monitored and a condition dependent climate system configuration may be effected only in the zone of the passenger compartment occupied by the monitored occupant. Alternatively, the condition dependent climate system configuration may be effected throughout the passenger compartment regardless of occupant location. Alternatively, only the behaviour of the driver may be monitored for some or all pre-specified conditions.

Because each person has different physical and mental characteristics, the control system 10 may be programmed with user specific behaviour criteria for one or more pre-specified conditions. The user specific behaviour criteria may be programmed by a user, or may be determined by monitoring the behaviour of a particular user and determining a user specific behaviour criteria in dependence on their characteristic behaviours. In each case, the user specific behaviour criteria may be stored and associated with the user identification to be implemented upon detection of that specific user.

Similarly, the condition dependent climate system configuration may be specified by each user and stored as a user specific condition dependent climate system configuration associated with their user identification. A user specific condition dependent climate system configuration may be selected and stored for one or more pre-specified conditions.

The control system 10 may be configured with one or more pre-defined use-case operation modes, wherein each pre-defined use-case operation mode is associated with a pre-defined use-case climate system configuration. The control system 10 may be configured to receive an input signal from the user interface 25 and/or from a user's mobile telephone for example, so that the user may request a specific pre-defined use-case operation mode.

Example pre-defined use-cases may include, but are not limited to, transporting hot/cold food in the footwell, carrying an infant in a child seat, carrying a pet in a carrier or tethered to a seatbelt. In each of these examples it may be desirable for the climate system 30 to operate in a specific pre-defined use-case operation mode which has a suitable pre-defined use-case climate system configuration which might include a pre-defined vent control scheme 28, pre-defined vent parameters 26 and/or predefined climate control parameters 27.

Taking the example of an infant in a child seat, the vent control scheme 28 and/or vent/parameters 26 may be programmed so that the air flow is directed towards the back rest of the seat in which the child seat is located. In this way, the air flow may rebound off the back rest towards the infant to provide an indirect cooling air-flow. Naturally, the climate control parameters 27 may also be adjusted in this example; for example, a fragrance may be distributed in this operation mode. In the example of transporting hot/cold food the vent control scheme 28, the vent parameters 26 and or the climate control parameters 27 may be programmed to cause warm/cold air to be directed in to the footwell only to keep the food hot/cold.

The control system 10 may be configured so that the pre-defined use-case operation mode ceases after a pre-determined period of time, upon request from the user interface 25 or mobile telephone/key fob, upon receipt of a signal indicative of a request for an alternative pre-defined use-case, or upon receipt of a signal indicating that a pre-determined climate or vehicle condition has been satisfied. For example, the pre-defined use-case climate system configuration may include a temperature, a humidity and/or a fragrance concentration. One or more of the sensors 40 may be used to provide an input signal indicating that the pre-determined climate or vehicle condition has been satisfied. For example, the electronic nose 44 may be used to determine fragrance concentration and/or air quality, and issue a sensor input signal 144 to the controller 20. Similarly, the internal climate sensor 41 may provide an input signal 141 to the controller 20 indicative in the temperature/humidity etc. inside the passenger compartment.

The control system 10 may be configured to determine if the pre-determined climate or vehicle condition has been satisfied based on the sensor input signal or signals and, if it is determined that the pre-determined climate or vehicle condition has been satisfied, cease operation of the climate system 30 in the pre-defined use-case operation mode. Once the pre-defined use-case mode is ceased, the control system 10 may be configured to return to the immediately prior mode of operation, to a user specified mode from the user interface 25 or mobile telephone/key fob or to a user specific climate profile. Alternatively, the control system 10 may be configured to move on to a second, or subsequent pre-defined use-case mode of operation after the preceding pre-defined use-case mode of operation is ceased.

The control system 10 may be configured to operate in a pre-conditioning mode of operation such that the climate system 30 may operate while the vehicle is parked. The pre-conditioning mode of operation may be used, for example, before the vehicle 1 is used for the first time after an extended period of non-use, or whilst parked for a short period of time to maintain a desired climate configuration for that period.

The control system 10 may be configured to receive an input signal indicative of a request for a pre-conditioning mode of operation. The control system 10 may be configured to store one or more pre-conditioning operation modes, wherein each pre-conditioning operation mode is associated with a particular pre-conditioning climate system configuration. The input signal may, for example be issued via the user interface 25 or by the user's mobile telephone or key fob.

The, or each, pre-conditioning climate system configuration may comprise a specific vent control scheme 28, vent parameters 26 and/or climate control parameters 27. It is particularly beneficial for the vent control scheme to be a dynamic vent control scheme in the pre-conditioning mode of operation so that the air-flow within the passenger compartment of the vehicle 1 in the pre-conditioning mode is dynamic, thereby helping to ensure an even distribution of climate conditions within the passenger compartment.

The control system 10 may be configured to store the or each pre-conditioning operation mode as a user specific pre-conditioning operation mode associated with a specific user identification such that upon receipt of a request for a pre-conditioning mode of operation, and upon receipt of a user specific identification signal, the control system 10 will default to the pre-conditioning mode of operation associated with that specific user.

The control system 10 may be configured with one or more pre-conditioning use-case operation modes, wherein each pre-conditioning use-case operation mode is associated with a specific pre-conditioning use-case climate system configuration. This is very similar to the pre-defined use-cases described above in relation to operation of the climate system 30 during conventional use of the vehicle 1 rather than during pre-conditioning when the vehicle is parked. The control system 10 may be configured to receive an input signal indicative of a request for a pre-defined pre-conditioning use-case (for example, from the user interface 25 and/or from a user's mobile telephone or key fob).

Example pre-defined pre-conditioning use-cases may include, but are not limited to, there being hot/cold food in the footwell, and/or a pet in the vehicle 1. In these cases the pre-defined pre-conditioning use-cases are similar to those described above in relation to operation of the climate system 30 during conventional use of the vehicle 1. The pre-defined pre-conditioning use-cases may also include use-cases related to the external climate conditions such as rain, frost, snow etc. Each pre-conditioning use-case may comprise suitable pre-conditioning use-case climate system configurations which may include a pre-defined vent control scheme 28, pre-defined vent parameters 26 and/or predefined climate control parameters 27.

The control system 10 may be configured so that the pre-conditioning operation mode comprises a dual pre-conditioning operation mode. The dual pre-conditioning operation mode comprises a primary mode and a secondary mode, wherein the primary mode comprises a primary climate system configuration, and wherein the secondary mode comprises a secondary climate system configuration. The primary and secondary climate system configurations may each comprise a static or dynamic vent control scheme 28 determined in accordance with primary and secondary vent parameters 26 respectively.

In the dual pre-conditioning operation mode the control system 10 is configured to commence primary mode operation by outputting a primary actuator control signal 132, and other climate system control signals 133, 134, 135, 136, 137 as required, to control the climate system 30 in accordance with the primary climate control configuration. After a pre-determined period of time, upon request, or upon receipt of an input signal indicating that one or more primary mode criteria have been satisfied, the control system 10 is configured to transition to the secondary mode operation by outputting a secondary actuator control signal 132, and other climate system control signals 133, 134, 135, 136, 137 as required, to control the climate system 30 in accordance with the secondary climate control configuration.

The primary mode criteria may include a climate and/or vehicle condition. The control system 10 may be configured to determine if the primary mode criteria have been satisfied based on input signals received from one or more of the sensors 40. For example, as discussed above in relation to operation of the climate system 30 during conventional use of the vehicle 1, the electronic nose 44 may be used to determine fragrance concentration and/or air quality, and issue a sensor input signal 144 to the controller 20. Similarly, the internal climate sensor 41 may provide an input signal 141 to the controller 20 indicative in the temperature/humidity etc. inside the passenger compartment.

The camera 42 may be used to determine if the windows 53 of the vehicle 1 are clear. The controller 20 may be configured to receive the input signal 142 from the camera 42 and to determine, based on one or more pre-defined criteria, if the windows 53 are sufficiently clear for the pre-conditioning mode of operation to move from the primary to the secondary mode of operation. For example, a percentage of transparent window area may be used as a window clear criterion. In the primary pre-conditioning mode of operation, the vents 31 may be directed primarily towards the windows to facilitate window clearing, whereas in the secondary pre-conditioning mode of operation the vents 31 may be operated to ensure consistent conditions throughout the passenger compartment.

In hot weather, particularly if the vehicle 1 is exposed to direct sunlight, the vents 31 may be directed to the seats and/or controls such as the steering wheel 51 and switches to cool these areas before use of the vehicle. This may be as part of a single or dual pre-conditioning operation mode.

The control system 10 may be configured to monitor the external physical and/or environmental conditions surrounding the vehicle 1 via one or more input signals 146 provided to the controller 20 from the external climate sensor 46. The control system 10 may monitor the external conditions and associate the external conditions with the current pre-conditioning climate system configuration. The control system 10 may then store this information and recall the pre-conditioning climate system configuration associated with particular external conditions and default to that pre-conditioning climate system configuration when the same or similar external conditions are identified.

The control system 10 may be configured to utilise any suitable system of the vehicle 1 as part of the climate system configuration in normal use of the vehicle 1, or in a pre-conditioning mode of operation. For example, the control system may be configured to operate one or more electrical systems such as Peltier devices located in the seats 52 or steering wheel 51, and/or electoral heating elements located in the windows 53.

The control system 10 may be configured to adjust the climate system configuration, whether in normal vehicle use or in pre-conditioning mode, in dependence on which parts of the climate system 30 is active, the steering wheel position, a sensed or inferred occupant head position, the extent of window opening, vehicle occupancy, the use of ancillary heating/cooling devices (such as window, seat or steering wheel) and/or the external environmental conditions.

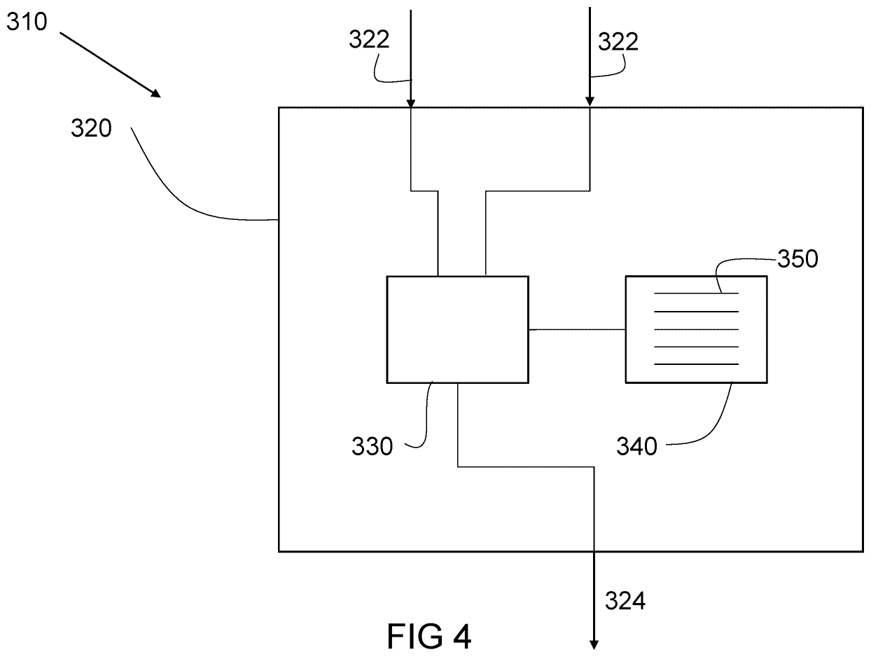

With reference to FIG. 4, there is illustrated a simplified example of a control system 310 such as may be adapted to implement the method described above. The control system 310 comprises one or more controllers 320 and is configured to determine a dynamic vent control scheme, wherein the dynamic vent control scheme defines a plurality of vent flow-directions; and output an actuator control signal to control the actuator to adjust the vent flow-direction in accordance with the dynamic vent control scheme to effect a dynamic vent operation mode.

It is to be understood that the or each controller 320 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 320 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 320 to implement the control techniques described herein (including some or all of the functionality required for the method described herein). The set of instructions could be embedded in said one or more electronic processors of the controller 320; or alternatively, the set of instructions could be provided as software to be executed in the controller 320. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 4, the or each controller 320 comprises at least one electronic processor 330 having one or more electrical input(s) 322 for receiving one or more of the input signal(s), and one or more electrical output(s) 324 for outputting one or more of the output signal(s). The or each controller 320 further comprises at least one memory device 340 electrically coupled to the at least one electronic processor 330 and having instructions 350 stored therein. The at least one electronic processor 330 is configured to access the at least one memory device 340 and execute the instructions 350 thereon so as to determine a dynamic vent control scheme, wherein the dynamic vent control scheme defines a plurality of vent flow-directions; and output an actuator control signal to control the actuator to adjust the vent flow-direction in accordance with the dynamic vent control scheme to effect a dynamic vent operation mode.

The, or each, electronic processor 330 may comprise any suitable electronic processor (e.g., a microprocessor, a microcontroller, an ASIC, etc.) that is configured to execute electronic instructions. The, or each, electronic memory device 340 may comprise any suitable memory device and may store a variety of data, information, threshold value(s), lookup tables or other data structures, and/or instructions therein or thereon. In an embodiment, the memory device 340 has information and instructions for software, firmware, programs, algorithms, scripts, applications, etc. stored therein or thereon that may govern all or part of the methodology described herein. The processor, or each, electronic processor 330 may access the memory device 340 and execute and/or use that or those instructions and information to carry out or perform some or all of the functionality and methodology describe herein.

The at least one memory device 340 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 320 have been described comprising at least one electronic processor 330 configured to execute electronic instructions stored within at least one memory device 340, which when executed causes the electronic processor(s) 330 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

As hereinbefore described, the climate system 30 comprises one or more vent 31 having adjustable flow-direction control and one or more actuators 32 which are configured to adjust the flow-direction of the vents 31 upon receipt of an actuator control signal 132 from the controller 20. As will be appreciated, the present invention is not limited to a specific climate system arrangement or a specific adjustable vent arrangement. However, examples of adjustable vent arrangements with which the present invention may be implemented are disclosed in patent applications GB2300160.5, CN202221565143.3 and CN202210704037.7, each of which is incorporated herein by reference.

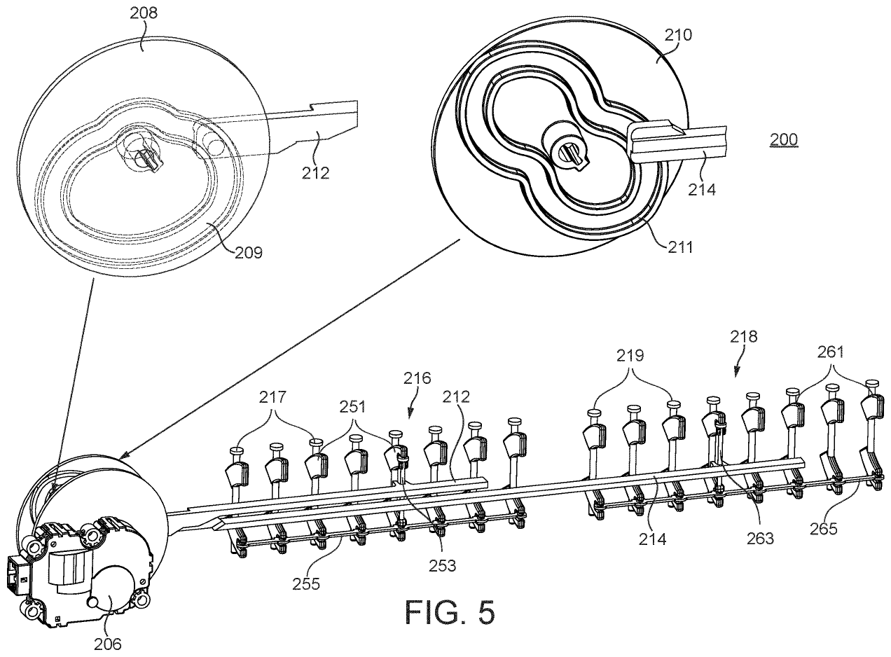

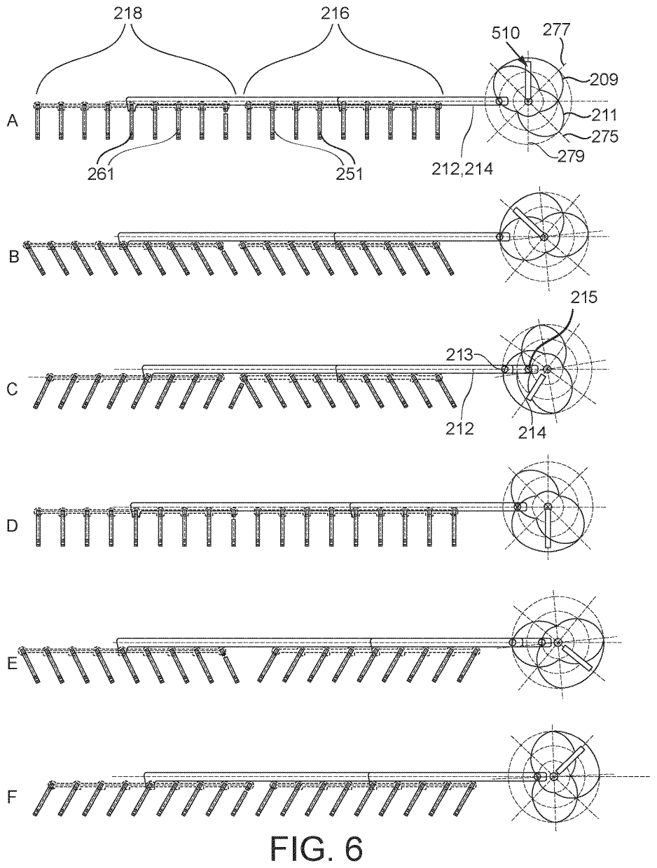

As illustrated in FIGS. 5 and 6, the adjustable vent arrangements described in these applications comprise: a first set of vanes 216 and a second set of vanes 218, each for directing air into the vehicle cabin; a first cam path 209 and a second cam path 211 defined by one or more cams 208, 210, the one or more cams being mounted to a common rotatable shaft; a first cam follower 212 operably coupled between the first cam path 209 and the first set of vanes 216, and a second cam follower 214 operably coupled between the second cam path 211 and the second set of vanes 218; wherein rotation of the common shaft causes the one or more cams 208, 210 to rotate, and the first and second cam followers 212, 214 to follow the respective first and second cam paths 209, 211, to adjust a relative angle of the first and second sets of vanes 216, 218. More particularly, the first cam follower 212 is provided with a pin 213 at one end thereof, which engages with the cam path 209 of the first cam wheel 208. Similarly, the second cam follower 214 is provided with a pin 215 at one end thereof, which engages with the cam path 211 of the second cam wheel 210.

The cam followers 212, 214 may be coupled to the sets of vanes so as to pivot each vane in the set about a respective vane axis as the cam follower moves in said action-direction. The vane axis of each vane in a vane set may be parallel to each other vane in the respective vane set.

Each of the vanes sets 216, 218 is rotatably mounted to the inside of the housing by respective pivots 217, 219. As the respective cam follower 212, 214 moves along its longitudinal axis, it displaces respective lever 253, 263 connected to a respective distributor lever 255, 265 which is itself connected to all the vanes 251, 261 of the respective set of vanes 216, 218 (at a position on the vanes at a distance from the pivots 217, 219). This enables the vanes 251, 261 to rotate about the pivots 217, 219, and thus to define different angles within the portion of the vent occupied by the vanes 251, 261. Since the two different portions of the vent respectively occupied by the first and second sets of vanes 216, 218 are able to direct air in different directions (from each other), very flexible control of airflow from the vent is possible.

Rotation of the common shaft, and thus following of the cam followers in their first and second cam paths, permits the respective angle of the first and second sets of vanes to be adjusted differently. Since portions of (but not all of) the two cam paths may be coincident, the first and second sets of vanes move together (with no change in their relative angle) for portions of the common shaft rotation, but move differently (with a change in their relative angle) for other portions of the common shaft rotation.

In this way, two different sets of vanes can be controlled differently (but not independently) using rotation of a single shaft.

Each of the cam paths may define a continuous loop. In this way a desired vane configuration as between the two vane sets may be achieved by a rotation of the common shaft, and the required degree of common shaft rotation may be minimised by selecting the direction of rotation of the common shaft.

While the present technique could be implemented manually, by way of the common shaft being rotated, directly or indirectly, by manual manipulation by a user (for example by turning a dial), preferably a motor is provided for rotating the shaft.

The controller 20 may control the position of the first and second sets of vanes by adjusting the rotational position of the common shaft via the motor. The controller 20 may be configured to select a direction of rotation of the shaft in dependence on which direction would reach a desired configuration for the first and second sets of vanes with the least shaft rotation.

It will be appreciated that the present technique could be used for vertical, horizontal or diagonal vanes.

The vent assembly that is controlled by the first and second set of vanes may have the first and second set of vanes arranged adjacent one another whereby, if the vanes of the first and second sets are aligned in the same direction, a single, broad air flow path exits the vent assembly, whereas, if they are oriented differently to one another, two flow paths in different directions exit the vent assembly, either in diverging directions where they remain separate, or in converging directions, where they mix to form a single focussed air flow. The rotation axes of the vanes of each set may be parallel.

The first and second cam paths may be defined such that the first set of vanes and the second set of vanes can be configured in each of:
a first, neutral, configuration, in which both sets of vanes are aligned in the same, forward, direction,
a second configuration in which both sets of vanes are aligned in the same, leftward, direction,
a third configuration in which both sets of vanes are aligned in the same, rightward, direction,
a fourth configuration in which the first set of vanes is aligned in a leftward direction and the second set of vanes is aligned in a rightward direction so as to converge and concentrate the airflow exiting the vent assembly, and
a fifth configuration in which the first set of vanes is aligned in a rightward direction and the second set of vanes are aligned in a leftward direction to diverge the airflow into separate streams.

In some implementations, with a complete rotation of the common shaft the first, neutral, configuration is arranged to arise twice. From a first one of the first, neutral, configurations, rotation of the common shaft in a first direction may move the vanes into the second configuration and rotation of the common shaft in a second direction may move the vanes into the third configuration. From a second one of the first, neutral, configurations, rotation of the common shaft in one direction may move the vanes into the fourth configuration and rotation of the common shaft in an opposite direction may move the vanes into the fifth configuration.

The presence of two neutral positions, in each case surrounded by a pair of other (related) configurations presents a natural feeling transition for the user—that is, it is not always necessary to transition through multiple unwanted modes before reaching a desired mode.

It will be appreciated that various changes and modifications can be made to the present invention without departing from the scope of the present application.

1. A control system for controlling a climate system of a vehicle, the climate system comprising a vent having adjustable flow-direction control and an actuator for adjusting a flow-direction of the vent, the control system comprising one or more controllers, the control system configured to:
determine a dynamic vent control scheme, wherein the dynamic vent control scheme defines a plurality of vent flow-directions; and
output an actuator control signal to control the actuator to adjust the vent flow-direction in accordance with the dynamic vent control scheme to effect a dynamic vent operation mode.

2. The control system of claim 1, further configured to:
receive a first input signal indicative of a dynamic vent parameter, wherein the dynamic vent parameter comprises a flow direction, a circulation direction, a pattern, a passenger compartment height, a passenger compartment width, a pattern width and/or a pattern height; and
determine the dynamic vent control scheme in dependence on the dynamic vent parameter.

3. The control system of claim 1, wherein the climate system comprises at least one of the following:
a fan having electronically adjustable control;
a heater having electronically adjustable control;
an air conditioner having electronically adjustable control;
a fragrance distribution system having electronically adjustable control; or an atmospheric air inlet having electronically adjustable control, wherein the control system is configured to:
receive a second input signal indicative of a climate control parameter, wherein the climate control parameter comprises a fan speed, a temperature, an air conditioning request, a fragrance request, or an air re-circulation request;
determine a climate control signal in dependence on the climate control parameter; and
output the climate control signal during dynamic vent operation mode to control the fan, the heater, the air conditioner, the fragrance distribution system, or the atmospheric air inlet to operate in accordance with the climate control signal.

4. The control system of claim 1, further configured:
to store the dynamic vent control scheme and
default to the stored dynamic vent control scheme, when the climate system is powered on, and/or when dynamic vent operation mode is initiated.

5. The control system of claim 4, further configured to:
receive a third input signal indicative of a user identification;
store the dynamic vent control scheme, as a user specific climate profile associated with the user identification; and
default to the user specific climate profile following receipt of the third input signal.

6. The control system of claim 1, further configured to:
receive a fourth input signal indicative of a vehicle occupant's behaviour;
determine, based on the indicated behaviour of the vehicle occupant and one or more pre-determined behaviour criteria, if the vehicle occupant is experiencing a pre-specified physical or mental condition;
if it is determined that the vehicle occupant is experiencing a pre-specified physical or mental condition, determine a condition dependent climate system configuration in dependence on the pre-specified physical or mental condition, wherein the condition dependent climate system configuration comprises one or more condition dependent dynamic vent parameters or one or more condition dependent static vent flow-directions, one or more condition dependent climate control parameters, and/or a condition dependent dynamic vent control scheme; and
determine the actuator control signal and/or a climate control signal in dependence on the condition dependent climate system configuration.

7. The control system of claim 6, further configured to:
monitor a vehicle occupant's behaviour;
determine one or more occupant specific behaviour criteria; and
adjust the pre-determined behaviour criteria for the occupant in accordance with the occupant specific behaviour monitored.

8. The control system of claim 1, further configured to:
receive a fifth input signal indicative of a request for a pre-defined use-case operation mode, wherein the pre-defined use-case operation mode comprises one or more pre-defined use-case vent parameters, wherein the one or more pre-defined use-case vent parameters comprise a pre-defined use-case static vent flow direction, or one or more pre-defined use-case dynamic vent parameters;
determine a pre-defined use-case vent control scheme in dependence on the pre-defined use-case vent parameters;
output an actuator control signal to control the actuator to adjust the vent flow-direction in accordance with the pre-defined use-case vent control scheme; and
switch operation mode from the pre-defined use-case operation mode to the dynamic vent operation mode after a pre-determined period of time, upon request, or upon receipt of an input signal indicating that that a pre-determined climate condition criteria or vehicle condition criteria have been satisfied.

9. The control system of claim 1, comprising:
a display screen; and
a touch and/or gesture operated user interface device, wherein the control system is further configured to:
display a graphical representation of the dynamic vent control scheme on the display screen;
adjust the dynamic vent control scheme in response to a user interaction with the user interface device; and
adjust the graphical representation of the dynamic vent control scheme in response to the user interaction with the user interface device, wherein the adjusted graphical representation is representative of the adjusted dynamic vent control scheme.

10. A climate system, comprising:
a vent having adjustable flow-direction control;
an actuator for adjusting a flow-direction of the vent; and
the control system of claim 1, including at least a first controller, wherein the at least a first controller is arranged to output a signal for causing the actuator to adjust the vent flow-direction in accordance with the dynamic vent control scheme to effect a dynamic vent operation mode.

11. A vehicle comprising the control system of claim 1.

12. A method for controlling a climate system of a vehicle, the climate system comprising one or more vents having adjustable flow-direction control and an actuator for adjusting a flow-direction of the vent, the method comprising:
determining a dynamic vent control scheme, wherein the dynamic vent control scheme defines a plurality of vent flow-directions; and
outputting an actuator control signal to control the actuator to adjust the vent flow-direction in accordance with the dynamic vent control scheme to effect a dynamic vent operation mode.

13. The method for controlling a climate system of a vehicle as claimed in claim 12, wherein the climate system has a dynamic vent operation mode in which a dynamic air movement pattern is automatically effected by said vents, the method further comprising:
displaying a graphical representation of the dynamic air movement pattern on a display screen, wherein the graphical representation comprises a representation of a width and/or a height of the dynamic air movement pattern;
adjusting the width and/or a height of the dynamic air movement pattern in response to a user interaction with a user interface device; and
adjusting the graphical representation of the dynamic air movement pattern in response to the user interaction with the user interface device,
wherein the adjusted graphical representation is representative of the adjusted dynamic air movement pattern.

14. (canceled)

15. A non-transitory, computer-readable storage medium storing instructions thereon that, when executed by one or more electronic processors, causes the one or more electronic processors to carry out the method of claim 12.

16. The control system of claim 2, further configured to store the dynamic vent parameter and default to the stored dynamic vent parameter when the climate system is powered on, and/or when dynamic vent operation mode is initiated.

17. The control system of claim 16, further configured to:
receive a third input signal indicative of a user identification;
store the dynamic vent parameter as a user specific climate profile associated with the user identification; and
default to the user specific climate profile following receipt of the third input signal.

18. The control system of claim 3, further configured to store the climate control parameter and default to the stored climate control parameter when the climate system is powered on, and/or when dynamic vent operation mode is initiated.

19. The control system of claim 18, further configured to:
receive a third input signal indicative of a user identification;
store the climate control parameter as a user specific climate profile associated with the user identification; and
default to the user specific climate profile following receipt of the third input signal.
